(19) United States
(12) Patent Application Publication
(10) Pub. No.: US 2005/0160417 A1
(43) Pub. Date: Jul. 21, 2005

(54) System, method and apparatus for multimedia display

(75) Inventor: Nandan Vinayakrao Kundetkar, Thane (W) (IN)

Correspondence Address: Stephen M De Klerk;Blakely Sokoloff Taylor & Zafman, Seventh Floor, 12400 Wilshire Boulevard, Los Angeles, CA, 90025, US

(73) Assignee: SPL Innotech Pte Ltd., Singapore (SG)

(21) Appl. No.: 10/498,847

(22) PCT Filed: Dec. 14, 2002
(86) PCT No.: PCT/SG02/00292

(30) Foreign Application Priority Data
Dec. 14, 2001 (SG) 0107912-8

(51) Int. Cl. G06F 9/44

(52) U.S. Cl. 717/168

(57) ABSTRACT

Apparatus for performing streaming download of multimedia content, in real time, the apparatus including a web server, an application programming interface, search means for conducting an on-line search, upgrading means for conducting an on-line upgrading, and translation means for receiving and displaying the multimedia content. The apparatus is given a unique identity, and any user of the apparatus is given a unique user identity.

### FIELD OF THE INVENTION

This invention relates to a system, method and apparatus for multimedia display and refers particularly, though not exclusively, to a system, method and apparatus for display of multimedia content obtained over a network.

Definitions

Throughout this specification a reference to a network is to include all forms of telecommunications networks including those over cable, fibre optic cables, wireless, satellites, and direct broadcast (as in television and radio). This includes local area networks, wide area networks, the Internet, and the World Wide Web.

### BACKGROUND TO THE INVENTION

There are many web sites that allow users to log in and download for viewing multimedia content over the Internet The content can be as small as a new graphic feature, or as long as a three-hour motion picture. Unfortunately, much of the content uses particular applications so a person wishing to use their machine their machine to view and/or listen to the content must have that particular application (or one compatible with it) on their machine, and must use it to view and/or listen to the content. With many such applications being proprietary, and being linked to a particular company, users must have many applications on their machines to be able to use the internet/web to its fullest. This is not satisfactory, involves users in extra expense, and consumes storage on their machine for many applications to achieve the same end result—on-line viewing and/or listening to content.

Furthermore, viewing a three-hour motion picture on a computer monitor is not ideal, particularly if an entire family wishes to be involved. It is far more preferable for such content viewing to be able to use the family entertainment center which may include a large screen television set, and surround-sound audio system, thus giving a theatre-like presentation. This also enables the family to be comfortable and to use furniture intended for such purposes. The quality of reproduction is also higher.

This also impacts an Internet telephone as this required use of a machine such as a personal computer. If an Internet camera is also being used, it can be inconvenient to do this from a bedroom or study. At times of a family or community event, communication with persons overseas using Internet telephony, and a camera, could be facilitated if the family's main entertainment area could be used.

It is therefore a principal object of the present invention to provide a user's machine that can be used with a monitor and/or a television receiver.

Another object of the present invention is to provide an integrated search engine that will allow multiple searching at the one time.

Yet another object of the present invention is to provide an interactive help desk over a network.

A final object of the present invention is to provide a system that can be automatically upgraded over a network.

### SUMMARY OF THE INVENTION

With the above and other objects in mind, the present invention provides a system for conducting an on-line search, the system including a user's machine instructing the search at a search engine, the instructions being sent to the search engine through a server, the server simultaneously conducting the search on at least one database of the server, the server providing the result of its search of the at least one database as a message to be send to the user's machine.

The present invention also provides a system for conducting an on-line search, the system including receiving at a server instructions for the search, the instructions being a copy of the instructions for a search as sent to a search engine, the server conducting a search of the server database, creating a search result message, storing the search result message at the server, receiving at least one identity pertaining to the user's machine, and sending the search result to the user's machine as a message.

The polling of the server may be by sending at least one unique identity to the server. The server may include a network file system server, a message server, and a database. The user's machine preferably includes a web server and an application processing interface.

In a further form, the present invention provides a system for a secure, on-line upgrading of an operating system of a user's machine, the system including the steps of sending a message to the user's machine of an upgrade after a signal for log on by the user's machine is sent to a server; the user's machine sending to the server confirmation to proceed with the upgrade; receiving from the server a universal resource locator at which the upgrade is to be found; and obtaining the upgrade and downloading into the user's machine as an overwriting of the un-upgraded operating system.

The invention also provides a system for a secure on-line upgrading of an operating system of a user's machine, the system, including the steps of a server sending a message to the user's machine of an upgrade after a signal for log on by the user's machine is sent to a server; the server receiving from the user's machine confirmation to proceed with the upgrade; the server sending to the user's machine a universal resource locator at which the upgrade is to be found; and obtaining the upgrade and downloading into the user's machine as an overwriting of the un-upgraded operating system.

There may be provided an automatic garbage step so that any files of the un-upgraded operating system that are overwritten are sent to garbage after the upgrade is complete. If the download is disrupted, the download may recommence at the last file of the download before the disruption. The system may operate as a pull system so that security firewalls can be maintained as long as the IP address of the server is not blocked.

In yet another form the present invention provides an interactive help desk system for operating over a network, the system including from a machine of a user receiving a help desk query; with the query receiving a unique machine identity of the machine and a unique user identity of a user of the machine; obtaining a profile of the user to facilitate dealing with the query and the user; and attending to the query.

The unique machine identity and the unique user identity may be provided automatically. The user profile may also be provided automatically. An interactive chat window may be opened on the user's machine for sending and receiving messages regarding the query. The operation of the user's machine may be taken over by the help desk so the help desk can control the functions of the user's machine. Communication between the user's machine and the help desk may be by messaging. The network may be the Internet.

The invention also provides a system for streaming download in real time of multimedia content including the on-line search system, the system for secure on-line upgrading, and the interactive help desk system; apparatus for performing an on-line search; apparatus for performing secure on-line upgrading; apparatus for performing an interactive help desk system; and apparatus for streaming download in real time of multimedia content.

In a final form the present invention provides apparatus for performing streaming download of multimedia content, in real time, the apparatus including a web server, an application programming interface, search means for conducting an on-line search, upgrading means for conducting an on-line upgrading, messaging, and translation means for receiving and displaying the multimedia content.

The apparatus may be given a unique identity, and any user of the apparatus may be given a unique user identity.

### DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawings:

FIG. 1 is an illustration of the system architecture;

FIG. 2 is a more detailed illustration of the system architecture;

FIG. 3 is an illustration of the software layers within the system;

FIG. 4 is a flowchart for an online upgrade of the system's operating system;

FIG. 5 is a flowchart for a first case of online support;

FIG. 6 is a flowchart for a second case of online support;

FIG. 7 is a representation of the architecture used for a search request; and

FIG. 8 is a flowchart for a search request.

### DESCRIPTION OF PREFERRED EMBODIMENT

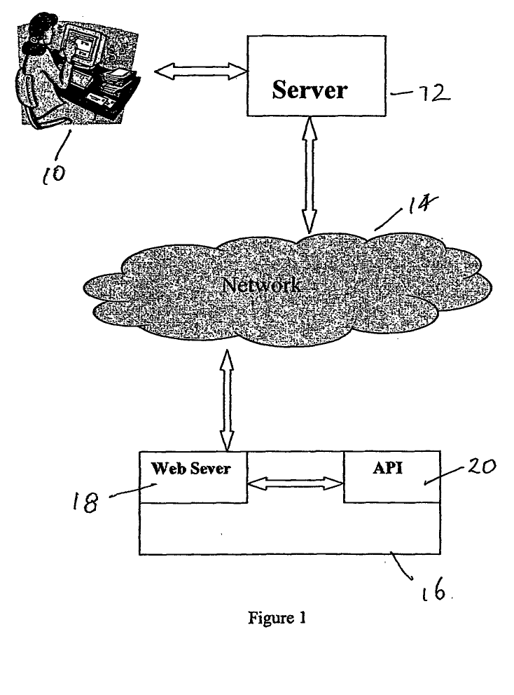

To first refer to FIG. 1, there is shown the overall architecture. A source 10 of multimedia content has a web site that can be accessed by a user's machine 16, using a network 14 through a server 12. The user's machine 16 has a web server 18 and an application-programming interface (“API”) 20 integrated into the user's machine 16.

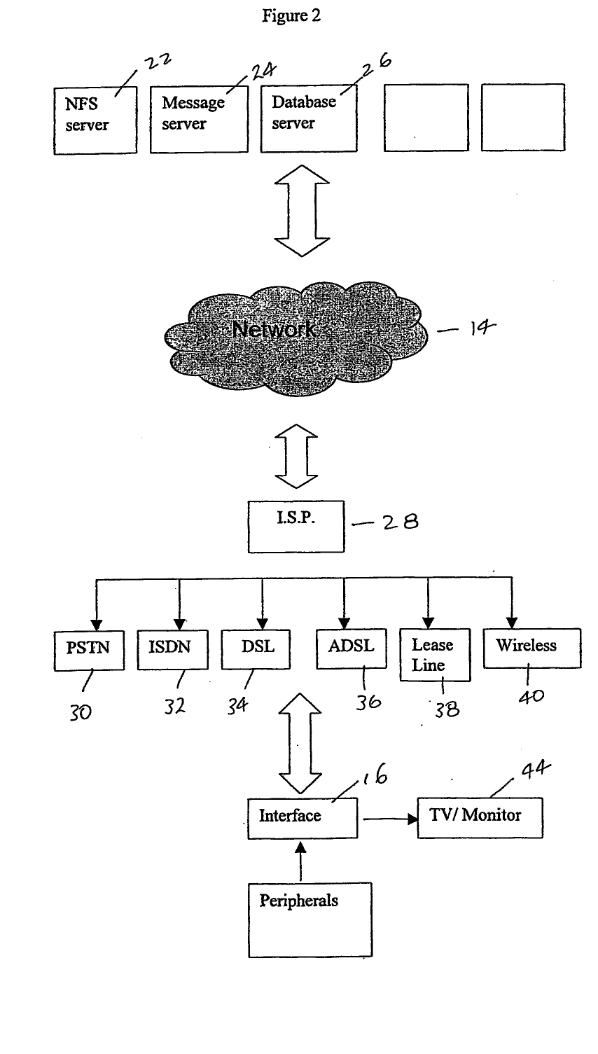

In FIG. 2, the server 12 may have a network file system (“NFS”) server 22, a message server 24 and a database 26. Other servers may be included within server 12 when or as required and/or desired.

The server 12 communicates with the user's machine 16 using a network, such as the Internet 14 and the usual Internet service provider (“ISP”) 28 of the user. The ISP 28 communicates with the user's machine 16 using a telecommunications network that may use one or more of PSTN 30, ISDN 32, DSC 34, ADSC 36, a leased line 38, or wireless 40. The user's machine 16 uses a monitor and/or a television receiver 44 for display purposes. As is stated above, a web server 18 is integrated into the user's machine 16. One or more of the usual peripheral devices such as, for example, keyboard, mouse, microphone, loud speakers, and camera, may be connected to the user's machine 16, if desired or required.

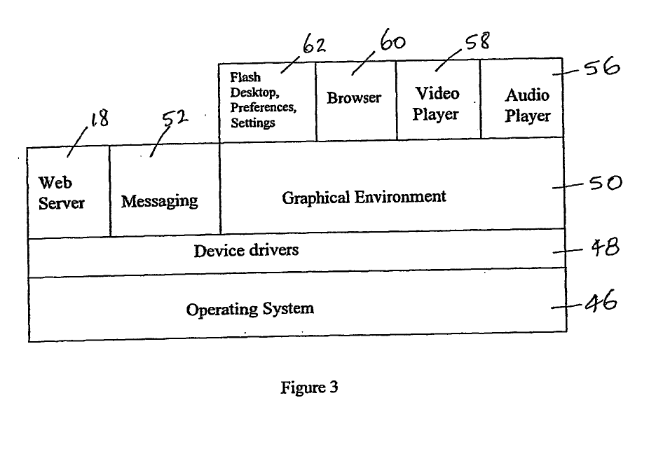

The software applications used in the machine 16 are shown in FIG. 3. The base layer is operating system 46. Then are the drivers 48 for the peripheral devices. Next are the graphics system 50, messaging system 52, and the web server 18. The final layer includes an audio player 56, video player 58, an Internet browser 60, and a desktop 62, which should include preference and settings. Each will now be described.

The operating system is preferably an open source system capable of operating with all known Internet and web browsers or operating systems, have multi-tasking, be preferably in the style of “UNIX”, and be “POSIX” (portable operating system interface) compliant. It is preferably provided with a security provision such that if copied it corrupts the copy so that the copy is unusable. Furthermore, the TCP/IP stack is preferably built into the operating system.

To further protect itself, the operating system makes the memory space in which it is loaded as protected. This ensures that the system does not crash, even in the event of critical application failures.

The operating system preferably has automatic garbage collection. In this way old versions of any routine are sent to garbage after the new version is loaded. This provides for efficiency in use of resources and reduces the storage capacity required. The operating system also uses a multi-layer, optimized file system thus providing it with the ability to compress and decompress files “on the fly” while writing or reading from small capacity block devices.

The operating system is preferably stored in a ROM with the RAM being for temporary file storage and processing. The RAM is fully cleared every time the receiver's machine 16 is switched OFF. It's also preferable that there be no built in disk drive. This facilitates dealing with viruses as viruses are normally designed to attack or use data stored on a disk drive with read and write functionality.

It is preferred that, where possible, the device drivers are included in the operating system so that no new application is required for a user to attach a standard peripheral device to their machine. Upon the user's machine 16 being switched ON, the operating system initializes the system; opens access to the network 14, launches the GUI and the window manager, and then starts the active desktop.

The device drivers included are for the usual known peripheral devices including, but not limited to: mouse, printer, external disk drive, camera, loud speakers, audio, and so forth. The audio driver preferably includes a radio tuner and may have MP3 and WAV format support.

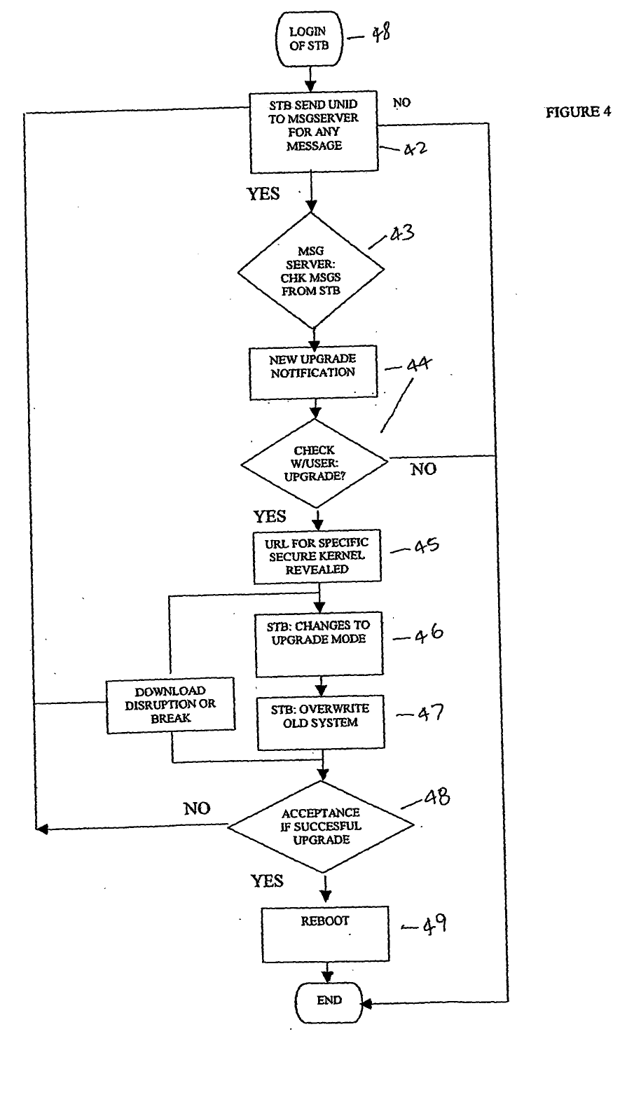

As shown in FIG. 4, upon opening access to the network, and starting the active desktop, the user is required to log in at 48. The unique identities of the user's machine 16, and the user, are sent to the server at 42. The server checks for any messages at 43. One message may be that there is an upgrade for the operating system. If so, at 44 a message is sent to the user advising them of the upgrade and requesting a yes/no answer to proceed immediately with the upgrade. If yes, at 45 the URL for the specific, secure upgrade is shown, and the user's machine 16 changes to an upgrade mode at 46. The upgrade is sent to the user's machine 16, at step 47, and overwrites the old operating system. If there is a disruption or break in the download, the system reverts back to before step 46. After a successful upgrade at 48, the user's machine 16 reboots at step 49 and the process ends. If the upgrade is not successful, or if the disruption is sufficiently severe, the process reverts back to before step 42. Preferably, in such an event, the system remembers where the disruption occurred during the download and recommences the download only from the commencement of the disruption.

By using a “pull” system secure firewalls can be maintained. Each user's machine 16 has a unique machine identity, and each user of that machine will have their own unique user identity. The identities may be in accordance with IEEE 802 standard, and may be a MAC address and/or a uniquely created address. Full profile data on each user is kept on the server 12 to be aware of which machines 16 have been upgraded, and those that haven't been upgraded. Appropriate messages can therefore be created by the server 12 for those machines 16 that haven't been upgraded in a timely manner, and be sent to them after they have logged on.

The messaging system is preferably as described in our co-pending patent application entitled “Messaging System” filed contemporaneously herewith, the contents of which are hereby incorporated by reference.

The data streaming system is preferably as described in our co-pending patent application entitled “Method for Display of Multimedia Content” filed contemporaneously herewith, the contents of which are hereby incorporated by reference.

The graphical environment (FIG. 3) is preferably derived from the known X server and incorporates a known window manager, particularly one that is lightweight, modular and customizable. It may support various skins and styles to be able to change the appearance and feel. For further information on such a graphics server see www.xfree86.org

The web server supports many known systems including, but not limited to: HTML4, CCS, JavaScript, Cookies, SSL, Java, Plugin, and non-blocking I/O; and has a built-in image viewer as well as supporting Internet Protocol V.6, and Xbel bookmark and management.

The web server includes at least one common gateway interface that is/are capable of making system calls on the user's machine. This provides interfaces for remotely calling the interfaces to assist the user with the settings of their machine and also assists in providing an interactive Internet help desk.

A chat window is provided to allow the user to be guided by the help desk. The interface also allows the help desk to take control of the user's machine to assist the user in initializing their machine by, for example, zooming the video, increasing the audio, launching the browser, and so forth. By having a built in web server it also allows the user to have remote access.

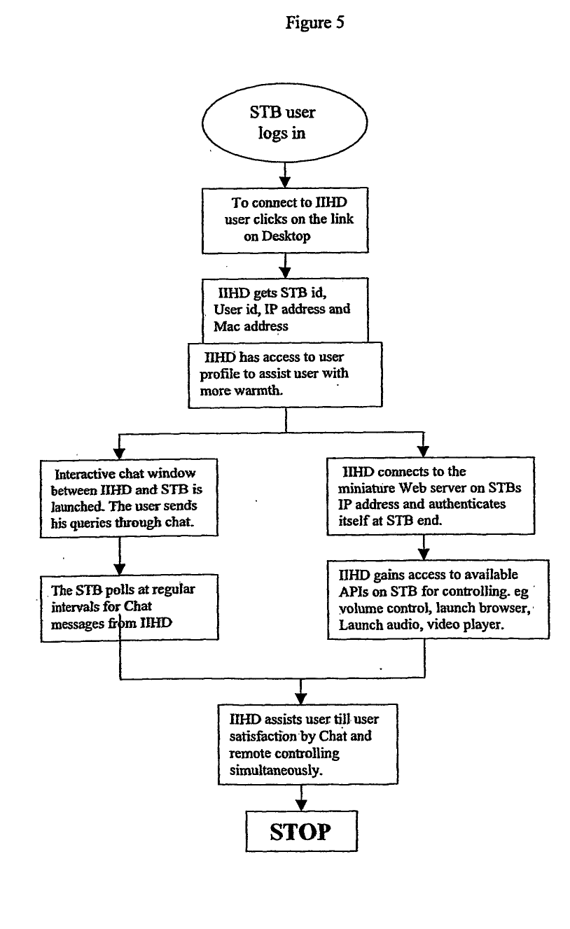

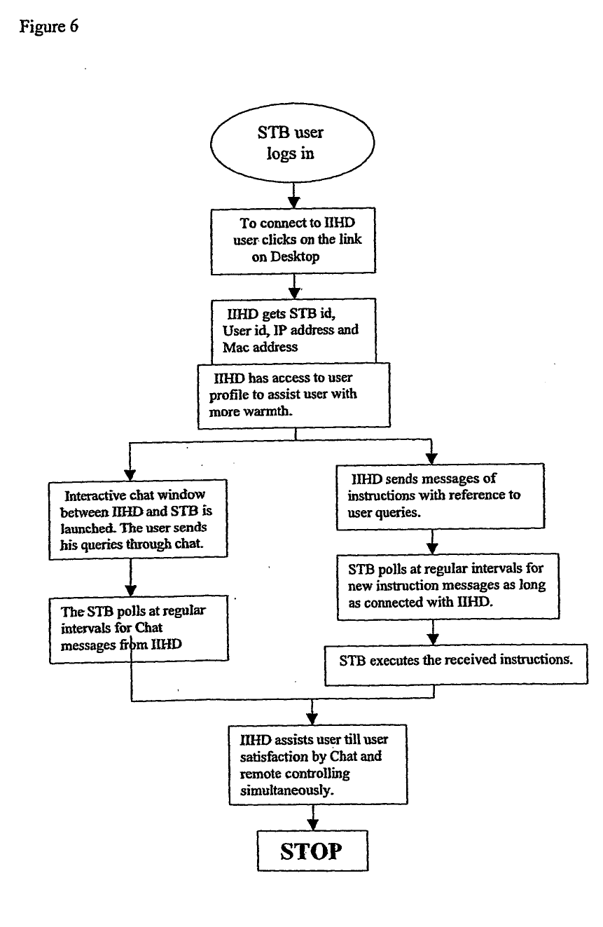

Two help desk functionalities are shown in FIGS. 5 and 6. To first refer to FIG. 5, the user logs in to server 12 using their machine 16. Upon the desktop being displayed, the user selects the link on the desktop and is connected to the interactive Internet help desk. The help desk is automatically provided with the machine 16 identity as well as the user's identity. These are supplemented by the machine's 16 IP and user identity. As such, the help desk is provided with to the user's profile. This may be on a call-up basis or automatically. This will assist the help desk in dealing with the user in a more friendly and responsive manner. The help desk can now take one or both of two possible actions:
1. open an interactive chat window on the user's machine 16 using machine 16 so the user can send their queries to the help desk using this window. The machine 16 polls at regular intervals for messages from the help desk using the messaging system referred to above; and/or
2. the help desk connects to the web server on the machine 16 and authenticates itself to the machine 16. The help desk can then control the functions of the machine 16 such as, for example, volume control, launch the browser, audio functions, video functions and so forth.

The help desk assists the user until the user is satisfied.

The functionality of FIG. 6 is the same as that of FIG. 5 except that the second option is the help desk sending messages to the user, the messages containing instructions in response to user queries. The instructions may be directed to the machine 16, and machine 16 may act on those instructions without user input. The machine 16 will regularly poll for messages, as is described above.

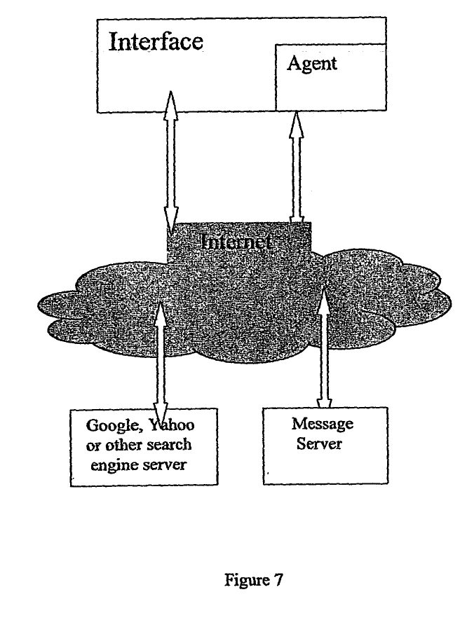

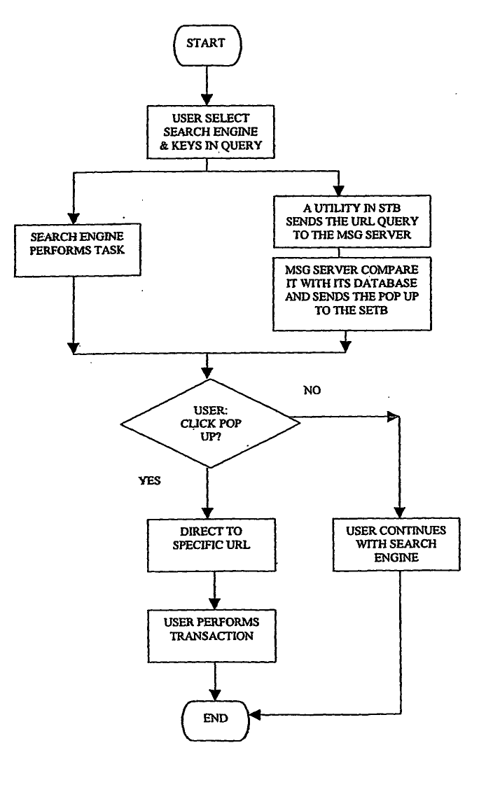

The browser includes a search function, and this is illustrated in FIGS. 7 and 8. The user selects the search engine they wish to use, and enters the search query. The search is instructed and the search engine performs the search. At the same time, a utility agent in the operating system sends the same query to the message server. The identities of the machine 16, and the user, are sent with the query. The message server searches its databases, and/or any database to which it has unrestricted and direct access, for any possible solutions to the query. If it finds one or more solutions, it sends those solutions to the machine 16 as a message. By being a message, it is sent to the user the next time the user's machine polls the server 12. In that way the user can instruct the search, and do something else until the result arrives. The user does not have to return to the web site of the search engine for the search result, if the result comes from server 12. If the required solution is amongst those provided, the user can select the required solution and proceed to perform the necessary transaction. If not, the user continues with the search by the search engine.

The browser is preferably an application that can handle multimedia input without having to open another application. It can receive and display: text, graphics, tables and charts, motion pictures, audio including radio, and so forth. The content to be displayed can originate from any known source and be able to be displayed. It is platform-independent.

In consequence, the desktop is similarly based. The desktop also takes note of and follows the user's individual settings such as, for example, home page, bookmarks, ISP, search engines, web sites, and so forth. The video and audio player may be known systems such as, for example, FLASH movie player.

The user's machine 16 includes a monitor and/or television receiver, for display purposes. Display includes an audio (radio) broadcast. If a television, it can be viewed in comfort, and the usual home entertainment units used to create a theatre-like effect. Even with a television, a user can do one or more of: surf the internet, view live events, view prerecorded motion pictures, listen to live audio, listen to prerecorded audio, messaging, audio/visual chat, and use various applications on the server. This may include remote storage of files using the server.

By having a unique ID for the machine 16, as well as for each user, the server 12 can maintain the profiles of each user of each machine 16. This may assist in providing detailed records when billing, usage patterns, and so forth.

As a multimedia device, the machine 16 should be able to support: VCD directly from a VCD player or from CDR, Window's bin image file; DVD directly from a DVD player using optional libdvd read for chapter support and libcss for encryption; MPEG 1/2 system streaming and Elementary stream file formats; RIFF AVI file formats; ASF v1.0 files; on screen display; subtitles; and remote control; and MPEG 4 functionality.

Whilst there has been described in the foregoing description a preferred embodiment of the present invention, it will be understood by those with the appropriate technical skills that many variations and modifications in details of design construction or operation may be made without departing from the present invention as claimed in the appended claims.

1. A system for secure on-line upgrading of an operating system of a user's machine, the system comprising:
an on-line browser available to a user that includes an on-line search system to search for multimedia and software upgrade content;
a first system to perform secure on-line upgrading of an operating system of the user's machine upon the user logging into the system and after checking whether there are upgrades for the operating systems; and
an interactive help desk system to provide user assistance in initialising their machine on request,
wherein the on-line search system searches for multimedia and software upgrade content such that the operating system of the user's machine is upgraded to enable viewing of the multimedia content, and the interactive help desk provides user assistance when requested.

2. A method for secure on-line upgrading of an operating system of a user's machine, the method comprising the steps of:
(a) sending a message by a server to the user's machine of an upgrade after a signal for log on by the user's machine is sent to a server;
(b) receiving by a server from the user's machine confirmation to proceed with the upgrade;
(c) sending by a server to the user's machine a universal resource locator at which the upgrade is to be found; and
(d) obtaining the upgrade and downloading into the user's machine as an overwriting of the un-upgraded operating system.

3. The method as claimed in claim 2, further comprising an automatic garbage step to send files of the un-upgraded operating system that are overwritten to garbage after the upgrade is complete.

4. The method as claimed in claim 2, wherein if the download is disrupted, the download recommences at the last file of the download before the disruption.

5. The method as claimed claim 2, wherein the system operates as a pull system so that security firewalls can be maintained.

6. The system as claimed in claim 1, wherein the interactive help desk system for operating over a network includes:
(a) a receiver module to receive from a user's machine, a help desk query, unique machine identity, and a unique user identity-;
(b) a profile module to obtain a profile of the user to facilitate dealing with the query and the user; and
(c) a response module to attend to the query,
wherein the operation of the user's machine is taken over by the help desk system to control the operation of the user's machine.

7. The system as claimed in claim 6, wherein the unique machine identity and the unique user identity are provided automatically by the user's machine.

8. The system as claimed in claim 6, wherein the user profile is provided automatically by the user's machine.

9. The system as claimed in claim 6, wherein an interactive chat window is opened at the user's machine for sending and receiving messages from the help desk system regarding the query.

10. The system as claimed in claim 6, wherein communication between the user's machine and the help desk system is by messaging.

11. The system as claimed in claim 6, wherein the network is the Internet.

12-25. (canceled)
